(19) United States
(12) Patent Application Publication
(10) Pub. No.: US 2026/0088914 A1
(43) Pub. Date: Mar. 26, 2026

(54) THREE-DIMENSIONAL MULTILAYER ELECTROENCEPHALOGRAPHY

(71) Applicant: FRANK EDUGHOM EKPAR, PORT HARCOURT (NG)

(72) Inventor: FRANK EDUGHOM EKPAR, PORT HARCOURT (NG)

(21) Appl. No.: 19/241,024

(22) Filed: Jun. 17, 2025

Related U.S. Application Data
(60) Provisional application No. 63/673,738, filed on Jul. 21, 2024.

(51) Int. Cl. H04B 13/00; G06F 3/01; G06N 3/0464

(52) U.S. Cl. CPC H04B 13/00; G06F 3/015; G06N 3/0464

(57) ABSTRACT

The present invention discloses systems, devices, algorithms and methods for the management, generation, processing and application of signals or data streams acquired or generated by leveraging or harnessing three-dimensional (3D) multilayer electroencephalography (EEG) systems, also known as Ekpar Electroencephalography (Ekpar EEG) systems, relying on a conceptual framework in which approximations to carefully selected representative features of the source or target of the bio-signals or biological substrate are utilized for characterization and/or management or modulation or moderation or control or stimulation of the underlying biological system. More specifically, an environment corresponding to selected features of the source or target biological substrate is created and a strategy that utilizes the corresponding or counterpart environment for the characterization and/or management or modulation or moderation or control or stimulation of the underlying biological system is pursued.

This United States (U.S.) Non-Provisional Application claims the benefit of U.S. Provisional Application Ser. No. 63/673,738, filed on Jul. 21, 2024, herein incorporated by reference.

### BACKGROUND OF THE INVENTION

### 1. Field of the Invention

The present invention relates generally to the field of nature-inspired bio-signal processing and allied fields. The invention relates to the management of biological substrates that could be achieved through the management of stimuli that characterize, modulate or moderate or influence any aspect of the biological substrate as well as through the management of any stimuli emanating from the biological substrate. Frank Edughom Ekpar introduced nature-inspired signal processing systems in U.S. patent application Ser. No. 13/674,035 encompassing three-dimensional (3D) multilayer electroencephalography (EEG) systems, also known as Ekpar Electroencephalography (Ekpar EEG) systems, as well as other systems relying on a conceptual framework in which approximations to carefully selected representative features of the source or target of the bio-signals or biological substrate are utilized for characterization and/or management or modulation or moderation or control or stimulation of the underlying biological system. The present invention relates to systems for the efficient processing and utilization of signals or data streams acquired from or directed towards the class of systems covered by U.S. patent application Ser. No. 13/674,035.

### 2. Description of the Prior Art

It is desirable to facilitate human machine interfaces (HMIs) such as brain computer interfaces (BCIs) through cost-effective non-invasive modalities like the EEG. However, modern EEG-based BCIs are hampered by low information transfer rates (measured in bits per second: the product of information transfer per presentation-in bits per item-and the presentation rate-in items per second) severely limiting their practical applications. The limitations of EEG-based BCIs are also present in applications that attempt to use the EEG to gain insights into the workings of the human brain both in healthy and diseased states for improved health outcomes and improvement of the human condition.

Although invasive systems such as the Neuralink interface [1] could provide higher information transfer rates and consequently greater practical impact, they are beset by demerits including the need for expensive, inconvenient and risky surgery and implantation of artificial devices in living tissue (with attendant ongoing risks of damage to living tissue) and would typically be limited to application in situations involving dire straits such as near complete paralysis or other severe impairment.

Aspects of the nature-inspired systems created by Frank Edughom Ekpar and delineated in U.S. patent application Ser. No. 13/674,035 resolve the aforementioned issues by enabling orders of magnitude higher information transfer rates than the state-of-the-art even in non-invasive configurations. This is especially pertinent in the non-invasive three-dimensional (3D) multilayer EEG systems, also known as Ekpar Electroencephalography (Ekpar EEG) systems, permitted by the work of Ekpar. However, state-of-the-art EEG data processing systems and algorithms including two-dimensional (2D) convolutional neural networks (CNNs) [2]-[6] are not optimally adapted to the processing of data from these 3D multilayer EEG systems.

### SUMMARY OF THE INVENTION

It is an object of the present invention to overcome the limitations of the prior art set forth above by providing systems for data generation and processing where bio-signals emanate from or are generated and directed to a plurality (at least two) of layers at one or more locations within a biological substrate such as neuronal populations within the brain or other biological substrate. The invention discloses systems, devices, algorithms and methods for the management, generation, processing and application of data streams utilized in the characterization or modulation or moderation or stimulation or excitation of the underlying biological substrate for beneficial outcomes. Capture of data streams from as well as generation and channeling of stimulation or excitation or modulation or moderation information directed at layers at a given ensemble (collection of transducers or sensors) site could be simultaneous or near simultaneous. It could also be based on other time domain configurations or other arrangements such as multiplexing, staggering, and so on.

In relatively simple embodiments, all ensembles under consideration feature the same number of layers. Consequently, a three-dimensional (3D) convolutional neural network (CNN) or comparable system-including four-dimensional (4D) or higher dimensional systems-could be harnessed without the need for extensive preprocessing of the data streams. However, situations could arise where data streams from one or more layers are missing. This could arise as a result of design considerations informed by the specific circumstances of the application of the system, resource constraints limiting the number of layers that could be incorporated, malfunctions limiting the availability of data streams from or to affected layers within affected ensembles or some other unforeseen circumstances or relevant considerations.

The present invention could lead to orders of magnitude increases in information transfer rates and spatial resolutions even for non-invasive EEG-based systems with far-reaching implications for many application domains (ranging from medicine to computing and in between)-such as the clarification of the functional organization of critical regions of the brain-in which the simultaneous acquisition of bio-signals or stimuli from multiple layers could lead to better understanding and more efficient operation.

Other advantages of the present invention include, but are not limited to, a greater wealth of actionable insights into the workings of the human brain for vastly more accurate prediction and diagnosis of a wide range of health conditions and much more efficient management of same for vastly improved health outcomes and quality of life. Yet other benefits include practical and cost-effective human machine interfaces (HMIs) such as brain computer interfaces (BCIs), brain-to-brain communication (including instances mediated by computing systems) for rehabilitation, entertainment, enhanced communication, conflict resolution, peaceful co-existence, prosperity and vast improvements in the human condition.

### BRIEF DESCRIPTION OF THE DRAWINGS

FIG. 1 illustrates a representative grid of transducer or sensor ensembles as elucidated by Frank Edughom Ekpar in U.S. patent application Ser. No. 13/674,035.

FIG. 2 depicts a schematic representation of a three-dimensional (3D) convolutional neural network (CNN) that could comprise part of the implementation of the systems disclosed in the present invention.

FIG. 3 is a schematic representation of a language model or signaling system that could be adapted to facilitate brain-to-brain communication according to the principles of the present invention.

### DETAILED DESCRIPTION OF THE PREFERRED EMBODIMENTS

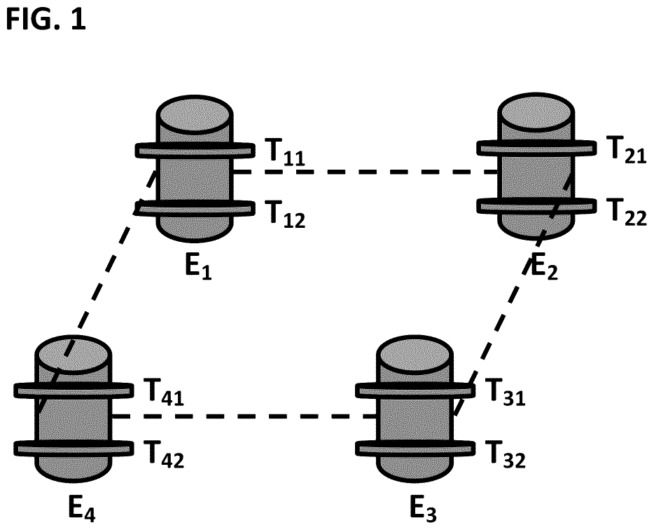

Depicting a grid of four ensembles labeled E₁, E₂, E₃ and E₄ disposed on an arbitrarily shaped N-dimensional surface (where N is 3 in this case but could be higher or lower), FIG. 1 features eight transducers labeled T₁₁, T₁₂ (associated with E₁), T₂₁, T₂₂ (associated with E₂), T₃₁, T₃₂ (associated with E₃) and T₄₁, T₄₂ (associated with E₄) operating in accordance with the principles disclosed in U.S. patent application Ser. No. 13/674,035. This is an illustrative grid of ensembles that could be adapted to capture EEG data streams (in which case the transducers would be sensors responsive to signals generated by neuronal populations at layers under the region of the scalp on the brain over which the ensemble is placed) or generate appropriately formatted stimuli for the stimulation or moderation or modulation of neuronal populations under the proximate region of the scalp on the brain.

Note that the ensemble (with two or more layers of transducers or sensors or incorporating two or more transducers or sensors as the case may be) in the 3D multilayer EEG systems of the present invention replaces what is typically referred to as a channel (with a single sensor or electrode) in state-of-the-art EEG systems.

The topology or shape and actual number of ensembles and number of transducers or sensors associated with each individual ensemble (approximately corresponding to the number of layers for that ensemble) could be determined by the performance and/or other requirements of the specific application and/or the availability of resources and/or any other relevant considerations. For 3D multilayer EEG systems, at least one of the ensembles must feature at least two transducers or sensors responsive to signals from neuronal populations or brainwave signals or generating stimuli for the stimulation or moderation or modulation or excitation of neuronal populations. Consideration could also be given to conventions for placement of electrodes such as the International 10-20 System or any other suitable convention and/or any other relevant considerations.

By grouping ensembles located at selected positions within a given placement convention, for example, the International 10-20 System, an extra dimension could be added to the data configuration or arrangement. As a case in point, signals or data from a grouping of at least four ensemble locations (that are not all located on a straight line) wherein at least one ensemble features two or more layers of transducers or sensors or electrodes could be configured as a four-dimensional (4D) data structure wherein the first two dimensions could refer to the spatial dimensions of the grouping, the third dimension could correspond to the direction of the two or more layers while the fourth dimension could refer to the feature space or time space or sample space of the signal or data stream.

Data streams could be captured from, or stimuli generated at, any subset of ensembles and within each included ensemble, any subset of transducers or sensors. Referring to FIG. 1, for example, data streams could be captured from or stimuli generated at T₁₁ and T₁₂ (domiciled at ensemble E₁) and T₃₂ (domiciled at E₃) while omitting E₂ and E₄ entirely and omitting T₃₁ from E₃.

Note that data acquisition from layers within ensembles could be simultaneous or near simultaneous and could also be based on other time domain configurations or other arrangements such as multiplexing, staggering, and so on.

Selective sampling or stimuli generation could be achieved through a control system implemented in hardware or software or combinations thereof or any other suitable implementations.

Furthermore, selective sampling or stimuli generation could be driven by design, resource constraints, malfunctions (where a layer or ensemble from which signals are expected or which is expected to generate stimuli fails to do so when required) and/or other relevant considerations.

Given a specific application, the optimum ensemble configuration (number of ensembles, number of layers in each ensemble, and so on) could be adaptively generated based on the performance and/or other requirements and/or in light of resource constraints.

Higher dimensional data streams such as four-dimensional (4D), five-dimensional (5D) and so on could be characterized and/or generated when extra modalities such as audio and video and/or other systems for capturing, generating, modulating or moderating and representing stimuli are incorporated into the system.

### Accounting for Missing Data

For applications that require data streams not available (for example, due to missing layers and/or ensembles, design, resource constraints and/or other relevant considerations), the missing data streams could be generated by harnessing an algorithm that assigns uniform values (such as 0) to the associated inputs and/or outputs. The missing data could also be automatically generated adaptively based on preset triggers or functions or by relying on stipulated system characteristics. Manual or operator-driven or agent-driven assignment of missing data, possibly through a suitably designed user interface, could also be carried out. The system could mix and match combinations of automatic and manual or operator-driven or agent-driven mitigation of missing data.

### General Considerations

Non-invasive configurations typically feature three-dimensional multilayer electroencephalography systems, also known as Ekpar Electroencephalography (Ekpar EEG) systems, connected operatively to the biological substrate (for example, through ensembles containing electrodes or sensors or generally transducers attached to the scalp through a saline-soaked sponge-filled medium or any other suitable medium or arrangement) without causing significant disruptions to the substrate. On the contrary, invasive (minimally invasive or more significantly invasive) configurations may involve disruptions to the substrate such as surgical (or preferably less invasive) implantation of ensembles containing electrodes, sensors or generally transducers.

Generally, any system, apparatus, method or algorithm capable of or actually leveraging or harnessing the characteristics of three-dimensional multilayer electroencephalography systems and/or associated signals or data or associated systems such as through the arrangement of data into three-dimensional, four-dimensional or higher dimensional structures corresponding to the topology of at least one ensemble or unit within the three-dimensional multilayer electroencephalography system (specific embodiments of which are described herein) falls within the scope of the present invention. Examples of systems, apparatuses, methods or algorithms leveraging or harnessing the characteristics of three-dimensional multilayer electroencephalography systems and/or their associated signals or data or associated systems are laid bare in the descriptions of the preferred embodiments. An apparatus or system that falls within the scope of the present invention comprises at least one component (such as a data acquisition unit in an electroencephalography device) that leverages or harnesses the characteristics of three-dimensional multilayer electroencephalography systems and/or associated signals or data such as through the arrangement of data into efficient three-dimensional, four-dimensional or higher dimensional structures corresponding to the topology of at least one ensemble or unit within the three-dimensional multilayer electroencephalography system. Similarly, a method or algorithm that falls within the scope of the present invention comprises at least one step (such as a data representation step in an electroencephalography data processing method or algorithm) that leverages or harnesses the characteristics of three-dimensional multilayer electroencephalography systems and/or associated signals or data such as through the arrangement of the data into efficient three-dimensional, four-dimensional or higher dimensional structures corresponding to the topology of at least one ensemble or unit within the three-dimensional multilayer electroencephalography system.

For simplicity, an apparatus or system is considered to be associated with or to comprise or be capable of or actually operating as a three-dimensional multilayer electroencephalography (3D Multilayer EEG) system, also known as Ekpar Electroencephalography (Ekpar EEG) system, and/or its associated signals or data if it incorporates or is connected or linked operatively to at least one ensemble or unit of transducers, sensors or electrodes comprising at least two layers of transducers, sensors or electrodes and/or associated signals or data.

Management of electroencephalography (EEG) systems—including Ekpar EEG systems—and/or associated signals or data generally involves sensing or measuring, processing, generating, utilizing for moderation, stimulation, modulation, excitation or other purposes, or interacting with the systems and/or associated signals or data to achieve desired ends such as those enunciated in the objects of the present invention.

### Three-Dimensional (3D) and Higher-Dimensional Convolutional Neural Networks (CNN) and Comparable Systems

Two-dimensional (2D) convolutional neural networks (CNNs) or 2D CNNs are known to excel at classification or pattern recognition tasks involving 2D input data such as traditional image data [7] that can be accessed and manipulated via vectors with a shape in the form: Width×Height where Width is the width of the image or number of columns and Height is the height of the image or number of rows or scan lines, typically in pixels. By expressing EEG data as 2D data structures in the 2D Channels×Features shape (analogous to the 2D Width×Height format) where Channels is the number of EEG data channels sampled and Features is the number of features (for example, Time in seconds multiplied by Samples per second) considered for the classification or pattern recognition or other tasks. Consequently, a 64-channel EEG data stream source with a sampling frequency or rate of 256 samples per second in a task where 2 second intervals of EEG data are considered for classification or pattern recognition or other purpose would yield 2D input data of the shape Channels×Features=64×(256*2)=64×512 where the number of channels is 64 and the number of features is 512 for each input vector.

2D CNNs, like other CNNs in other dimensions (1D, 3D, 4D, and so on), employ a variety of layers such as convolutional layers, fully connected layers and pooling layers and have been successfully applied to classification or pattern recognition and other tasks pertaining to EEG data processing [2]. 2D CNNs are not optimized for the 3D and higher dimensional (when coupled with other modalities or sources or targets) data generated or required by the 3D multilayer EEG systems of the present invention. 3D, 4D or higher dimensional CNNs are a better fit since they can be coupled to the 3D or higher dimensional data involved in a straightforward manner, more efficiently preserving spatial and other 3D and higher dimensional relationships in the data.

Three-dimensional (3D) convolutional neural networks (CNNs) or 3D CNNs have been applied to volumetric image semantic segmentation [8] and other 3D data processing systems. They have not been applied to EEG data processing since state-of-the-art EEG systems generate 2D data vectors in the 2D Channels x Features shape or format. The present invention adapts 3D and/or higher dimensional CNNs and/or comparable 3D, 4D or higher dimensional systems for the processing (including management and generation) of data associated with 3D multilayer EEG systems.

For the 3D multilayer EEG systems of the present invention, a typical input vector could be of the 3D shape: Layers×Ensembles×Features where Layers refers to the number of layers (approximately corresponding to the number of transducers or sensors on an ensemble) in an ensemble, Ensembles represents the number of ensembles in the given system and Features represents the number of features (for instance, Time multiplied by Samples per second) under consideration in the given classification, pattern recognition or other task. Thus, for a 3D multilayer EEG system with a sampling frequency or rate of 1000 samples per second harnessed in a task with 5-second data streams under consideration and given the ensemble grid depicted in FIG. 1 with 4 ensembles and 2 transducers or sensors per ensemble, the 3D input vector shape would be 2×4×5000 where the first dimension (Layers) has 2 elements, the second dimension (Ensembles) has 4 elements and the third dimension (Features) has 5×1000=5000 elements.

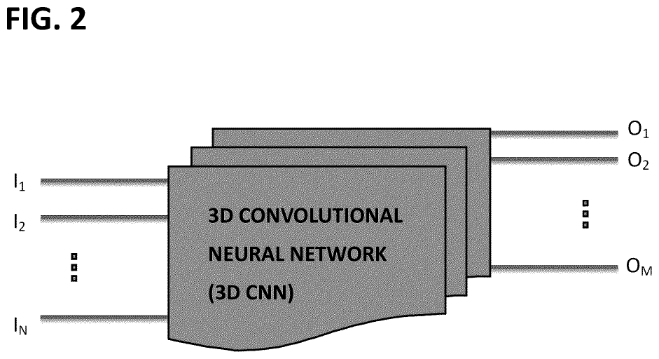

FIG. 2 shows a representation of an embodiment of a 3D CNN that could be employed in the present invention. In FIG. 2, I₁, I₂, . . . , I_{N} represent inputs to the 3D CNN while O₁, O₂, . . . , O_{M} represent the outputs of the 3D CNN. These inputs could be mapped to the 2×4×5000 shaped 3D input vectors in the situation described in the foregoing. The outputs could be mapped to the output vectors representing the output classes or patterns (for example, for events, actions such as limb movements and/or associated motor imagery, concepts, words, cognitive states such as relaxed, stressed, agitated, happy, and so on) or other uses such as visualization for the tasks under consideration.

Higher dimensional CNNs such as four-dimensional (4D), five-dimensional (5D) and so on could be harnessed when extra modalities such as audio and video and/or other systems for capturing, generating, modulating or moderating and representing stimuli are incorporated into the system. Systems comparable to CNNs or any other system capable of leveraging the 3D, 4D, 5D and/or higher dimensional structure and/or other characteristics of the data streams under consideration could also be utilized in 3D, 4D, 5D and/or higher dimensions as required.

The architecture, including, but not limited to, the exact types and numbers of layers (for example, convolutional layers, pooling layers, fully connected layers, and so on) in the CNN or comparable system (or any system capable of leveraging the characteristics of 3D multilayer EEG systems and associated systems) could be determined by design, experimentation, considerations of the performance requirements and resource constraints of the implementation or any other relevant considerations.

### Implementations and Simulations

The systems and/or components described in the foregoing detailed description of the preferred embodiments of the present invention could be implemented in hardware (including, but not limited to the use of specialized hardware, computer systems, neuromorphic chips and/or comparable systems) or software (including, but not limited to the use of code written in programming languages such as C, C++, JAVA, Python, and on on) and/or the use of suitable combinations of hardware and/or software and/or any other suitable system.

Simulations of the entire system or parts of the system could also be built and used alone or in combination with other systems.

### Brain-to-Brain Communication

This section specifies how the present invention reduces to practice and enables brain-to-brain communication.

In the context of the present invention, brain-to-brain communication refers to communication or exchange of one or more messages between a set of one or more senders and a set of one or more receivers wherein at least one entity (either a sender or a receiver) in the collection of communicating entities wields (wears or is operatively connected to) a 3D multilayer EEG system.

Brain-to-brain communication can be non-invasive or invasive or based on any combination of non-invasive and invasive strategies for any combination of senders and receivers.

In non-invasive applications, the principles of the present invention could be utilized to capture, store, process and decipher brainwave signals from one or more participants (senders) wielding (that is, wearing or operatively connected to) a 3D multilayer EEG system and generate messages to be transmitted to one or more receivers. A receiver or receivers could also wield (wear or operatively connect to) the 3D multilayer EEG system and have their brainwave signals captured, stored, processed and deciphered with corresponding messages generated and transmitted to one or more receivers. Note that the receiver(s) need not wield the 3D multilayer EEG system if at least one sender wields it. Similarly, the sender(s) need not wield the 3D multilayer EEG system if at least one receiver wields it.

For minimally invasive or invasive applications, the principles of the present invention could be utilized to generate stimuli or signals for the modulation, moderation or stimulation or excitation of one or more layers of the biological substrate to effect delivery of the messages and facilitate communication. Generation of stimuli or signals could be accomplished through generative adversarial neural networks (GANs) or any other suitable means.

In situations where brain-to-brain communication is mediated by computers, messages could be transmitted using computers or computer networks and displayed on computer monitors in the form of pictures, videos, symbols or any other suitable representations or combinations thereof. The language or signaling system or sets of symbols used for communication would preferably be easy to understand for all participants. In order to reap the benefits of computer-mediated brain-to-brain communication, brainwave signals from a sender would be decoded-for example using a suitably trained artificial intelligence (AI) model-and transformed into a representation agreed upon by the participants and that representation would be displayed to the receiver on a computer screen, for instance. The receiver in this case may also have their brainwave data captured, decoded and transformed into a suitable representation for any selected receiver or receivers or to the original sender for bi-directional computer-mediated brain-to-brain communication. Note that it is sufficient for at least one of the entities engaged in the communication to wield a 3D multilayer EEG system. For direct brain-to-brain communication, relevant sections and/or layers of the brain of the receiver could be stimulated or modulated or moderated or excited to effect delivery of the intended messages.

More specifically, at least one of the communicating entities wields a 3D multilayer EEG system built or operating in accordance with the pattern illustrated in FIG. 1 of the preferred embodiments wherein at least one of the ensembles comprises a plurality (two or more) of transducers or sensors wherein the ensembles are disposed on an arbitrarily-shaped three-dimensional surface. The exact shape or topology of the grid of ensembles and number of ensembles and number of transducers or sensors or layers associated with each ensemble are determined by factors such as the characteristics (for example, what area of the brain is most closely associated with the stimuli under consideration), stipulated performance metrics for the specific application, availability of resources, conventions for placement of electrodes (such as the International 10-20 System or any other suitable convention), and/or any other relevant considerations.

Consider a non-invasive computer-mediated configuration wherein the 3D multilayer EEG system is placed on the scalp of at least one of the communicating entities and adapted to acquire EEG data streams. The data could be fed as input to the 3D CNN illustrated in FIG. 2 of the preferred embodiments. The 3D CNN could be implemented as software written in a programming language such as C, C++, Python, JAVA, and so on, and running on a computing system or in hardware in a neuromorphic chip or any other suitable system. The architecture of the 3D CNN including the numbers and types of layers, activation functions, optimization algorithms and other characteristics to incorporate depends on the performance requirements and resources of the communicating entities and could be determined through experimentation, automated pipeline generation or using some other suitable methodology. Given the specific design depicted in FIG. 1 of the preferred embodiments wherein each ensemble comprises two sensors or transducers and a sampling frequency of 20,000 samples or features per second for the 3D multilayer EEG system and a feature duration of 3 seconds (resulting in a feature vector length of 3 seconds×20000 features per second=60000 features or samples), the typical three-dimensional shape of the input to the 3D CNN would be: Layers×Ensembles×Features=2×4×60000. Note that the ensemble count (number of ensembles) of 4 is for illustration only. In practice, the number of ensembles is determined by factors such as the characteristics of the application, the target performance metrics, the availability of resources and/or any other relevant considerations. Generally, the 3D CNN would first be trained (typically offline) using a large number of EEG data samples possibly from multiple participants over one or more sessions or from a single participant over one or more sessions and corresponding classes representing aspects of the language or signaling system to be used in communication before being harnessed to generate inferences from EEG data streams.

As evident from the foregoing, the brain-to-brain communication system described herein leverages or harnesses the characteristics of 3D multilayer EEG systems and/or associated signals or data or associated systems including through the arrangement of data into three-dimensional, four-dimensional or higher dimensional structures corresponding to the topology of at least one ensemble or unit within the 3D multilayer EEG system for efficient operation.

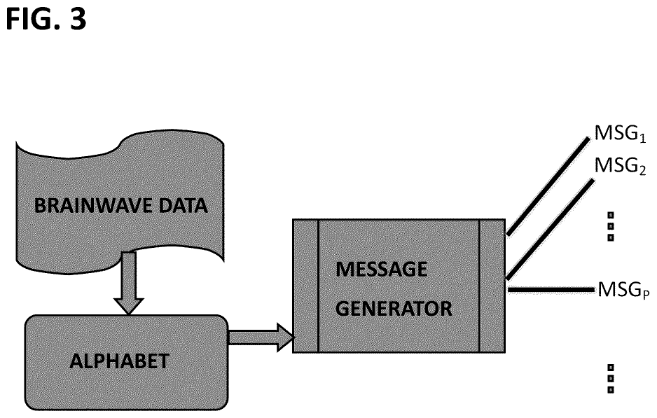

FIG. 3 depicts a language or signaling system model that could be adapted for brain-to-brain communication in accordance with the principles of the present invention. BRAINWAVE DATA in the form of data streams from the 3D multilayer EEG system is processed to extract patterns corresponding to one or more elements in an ALPHABET. The processing and classification for extraction of patterns could be effected via 3D CNNs as delineated in the present invention. Other processing and/or classification systems, algorithms and/or devices could be employed. The inferences or outputs of the processing and/or classification pipeline are transformed into corresponding elements in the ALPHABET. The ALPHABET could comprise words or concepts in a natural language such as “egyetem” (meaning university) in the Hungarian language. The words or concepts could in turn be associated with specific symbols or data such as pictures or videos or other representations of concepts and/or objects. The elements in the ALPHABET could represent actions or events or thoughts or cognitive states such as raising the right hand, raising the left leg, relaxed or calm state, agitated state, and so on that could be associated with the participant generating the brainwave data or at whom the brainwave data is targeted. Essentially, the elements of the ALPHABET could be any symbols or data or representations of symbols or data that could find utility in communication. Practical constraints pertaining to computing and other relevant resources would generally limit the ALPHABET to a finite set of elements. The composition of the ALPHABET could be determined by the specific requirements and resources of the communicating entities and/or systems utilized or any other relevant considerations.

The MESSAGE GENERATOR combines elements from the ALPHABET with a set comprising connecting symbols to generate messages for exchange within the brain-to-brain communication system. The chosen set of connecting symbols (in the MESSAGE GENERATOR) for a given instant for a given set of elements from the ALPHABET could be empty, in which case the elements from the ALPHABET are presented verbatim for further utilization and/or processing within the brain-to-brain communication system. For example, brainwave data corresponding to the thought of “going” or “moving” and subsequent brainwave data (in any suitable or agreed upon order of presentation) corresponding to the concept of “university” could cause (after inference generation by a 3D CNN, for instance) the symbols “jár” (meaning going) and “egyetem” (meaning university) to be selected from a Hungarian language ALPHABET and combined with the suffix “re” (the appropriate form of the “to” preposition in the Hungarian language) as a connecting symbol after the word “egyetem” by the MESSAGE GENERATOR to generate the message “egyetemre jár” in the brain-to-brain communication system. Note that instead of words, phrases and/or sentences a video illustrating the concept of going to a university could be generated or retrieved and emitted as the appropriate message from the MESSAGE GENERATOR. Other suitable representations could be utilized as well.

The collection of connecting symbols incorporated into the MESSAGE GENERATOR could be chosen on the basis of the nature of the language model (for example, pertaining to a common language understood by the participants) and/or the purpose of the communications and/or any other relevant considerations.

In FIG. 3, the messages generated by the MESSAGE GENERATOR are labeled MSG₁, MSG₂, . . . , MSG_{P}, . . . , where P is a non-negative whole number indicating the number of messages possible. Theoretically, there is no limit to P or number of messages. In practice, P could correspond to a number (ideally very large) representing how many meaningful (to the communicating entities) messages the system could generate. Rules for generation of messages could be programmed into the MESSAGE GENERATOR and adapted to generate messages as required using any suitable message generation mechanism including, but not limited to, naïve concatenation of the symbols or data created via the ALPHABET and BRAINWAVE DATA.

The language model or signaling system could be implemented in software with the BRAINWAVE DATA component featuring a device driver or comparable service or system for the acquisition and/or generation of brainwave signals, the ALPHABET as data structures and/or code associated with the processing and/or pattern classification system which could be implemented as software in a suitable programming language, the MESSAGE GENERATOR as software integrating the other components of the system and emitting messages as described herein. The generated messages could be presented as images, videos, text or any symbols or data (which could be in the form of tactile stimuli such as Braille for the visually impaired or any other suitable representation) or combination of symbols or data for display on computer screens, holographic systems, virtual and augmented reality systems, played out as sounds or presented in any manner suitable to the message type and the performance and resource specifications of the system. They could also be used to generate stimuli for the stimulation or moderation or modulation or excitation of selected parts of the brain of the receiver in direct brain-to-brain communication systems. The input brainwave signals or data could also be simulated. Any combination of components could be implemented as hardware or as any combination of hardware and/or software implementations or any other suitable implementations. Communication could be locally mediated by computers or distributed via a computer or comparable network.

A control unit could be incorporated into the system to control aspects of the operation of the system. For bidirectional communication, the control unit could determine when and if a specific sender or receiver could send or receive messages. For communication between more than two participants, the control unit could determine which participant could send or receive messages and in what direction at a given time. The control unit could generally be adapted to moderate and/or facilitate the exchange of messages between the participants in the brain-to-brain communication system in any desired manner. The control unit could be implemented as server software (written in a programming language such as C++, JAVA, Python, and so on) running on a computer system with the participants represented as clients (similarly implemented as software based on requirements and/or other relevant considerations) connected to and interacting with the server. In the client-server architecture, the Transmission Control Protocol (TCP)/Internet Protocol (IP) or (TCP/IP) framework or any other suitable protocol or framework could be utilized for client-server communication. The server and/or associated clients could also be implemented in hardware in their entirety or have their components implemented as a combination of hardware and software modules or using any other suitable implementations.

Alternative configurations of the system including the control unit and components representing the participating entities besides the client-server model could be utilized. For example, in applications where a sender transmits one or more messages to one or more receivers who are not expected to send messages to any receiver, a broadcast configuration could be employed. Other suitable configurations could be harnessed as required.

Note that any desired subset of ensembles and transducers or sensors (in non-invasive configurations) from any desired layers of the 3D multilayer EEG system could be sampled for data or harnessed for data generation for the BRAINWAVE DATA component of the language model or signaling system. Measures for mitigation of missing layers or data streams in applications requiring data from such layers are delineated within the foregoing description of the preferred embodiments. The control unit could be adapted or programmed to determine what subset of data to collect and/or generate.

The entire brain-to-brain communication system including the control unit and language model or signaling system or aspects thereof could be simulated and used for a wide variety of purposes including experimentation in communication and/or training. Conversely, the entire system or any aspect thereof could be implemented in hardware and/or using embedded systems. Any suitable combination of hardware and software implementations or any other suitable implementations in the light of performance and/or resource and/or other relevant requirements and/or considerations could be employed.

While Frank Edughom Ekpar [9] suggested that 3D multilayer EEG systems, also known as Ekpar Electroencephalography (Ekpar EEG) systems (earlier introduced as part of a range of nature-inspired signal processing systems by Frank Edughom Ekpar in U.S. patent application Ser. No. 13/674,035) could provide a viable pathway to computer-mediated brain-to-brain communication, the present invention reduces to practice actual systems for brain-to-brain communication including those that leverage or harness the characteristics of 3D multilayer EEG systems and/or associated signals or data or associated systems as set forth in the foregoing.

### Comprehensive Artificial Intelligence (AI)-Driven Healthcare System

Frank Edughom Ekpar created Scholar Medic, a comprehensive artificial intelligence (AI)-driven healthcare system [10] that supports three-dimensional multilayer EEG systems and generates actionable insights for clinical decision support and can save millions of lives and improve living conditions for millions of people around the world by reducing the economic, social, psychological and physical burden of the health conditions that it is harnessed to predict and possibly prevent, detect early, diagnose, treat and manage more efficiently.

In resource-constrained environments like low-and middle-income countries (LMICs) with disproportionately high disease burdens and abysmally low doctor-to-patient ratios exacerbated by the brain drain occasioned by emigration of healthcare professionals to developed countries for greener pastures, Scholar Medic enables a single medical doctor or similar licensed healthcare professional to efficiently manage a number patients that would otherwise require ten (10) or more such personnel to manage. This dramatically improves health outcomes and saves lives.

The systems disclosed in the present invention including those for leveraging or harnessing the characteristics of three-dimensional multilayer EEG systems and/or associated signals or data could be incorporated into the aforementioned comprehensive AI-driven healthcare system for efficient management of signals or data associated with the three-dimensional multilayer EEG systems supported by the healthcare system for improved health outcomes.

### Information Management

The data or information in any aspect or any combination of aspects of the present invention such as the generation or acquisition or simulation or processing of 3D EEG or higher dimensional data streams and/or the 3D and/or higher dimensional CNNs and/or any other suitable data processing systems and/or the language model or signaling system and/or MESSAGE GENERATOR and/or any other aspect or any combination of aspects thereof could be represented or managed using the principles of the Arbitrary Dimensional User Interfaces highlighted in International Application Number PCT/US2012/066159 or U.S. patent application Ser. No. 13/681,424.

Any information associated with any aspect of any embodiment of the present invention could be managed as elements in a universal file format. Such a universal file format would specify a header identifying the file type and containing information as to the number, types, locations and sizes of the elements it contains. Each element in the file is in turn described by a header specifying the type of the element, its size and any relevant data or attributes and the types, locations and sizes of any additional elements it contains. By making use of self-describing elements in the manner explained in the foregoing, the universal file format would be able to store an arbitrary element having an arbitrary number and types of other such elements embedded in it. For a more concrete and specific example, information associated with data for visualization or simulation of states and/or events and/or actions of a biological substrate could be managed as elements in the universal file format described in the foregoing. Furthermore, information associated with any transformations required to translate any aspects of a biological substrate such as a characterization of its state in a suitable mathematical or other form into messages for brain-to-brain communication between two or more participants could also be managed as elements in the universal file format described in the foregoing.

### Alternative Embodiments

Although the foregoing preferred embodiments have highlighted non-invasive EEG or similar systems, the principles of the present invention apply, without limitation, to alternative embodiments including invasive systems where electrodes are implanted directly in the brain or other biological substrate.

The foregoing description of the preferred embodiments of the present invention disclosed specific systems, devices, algorithms, experimental setups, mathematical analyses, stimulus types, and so on. In particular, systems based on electrical or electrochemical stimuli were disclosed. However, one of ordinarily skill in the art would readily appreciate that any other suitable types of stimuli including chemical, electrical, magnetic, optical, acoustic, mechanical, electromagnetic, ultrasound, microwave, radio, gamma ray, x-ray, ultraviolet light, white light, infrared light, laser, or any other stimuli associated with biological substrates-both living and non-living or both animate and inanimate-could be utilized in implementing the present invention.

It should be understood that numerous alternative embodiments and equivalents of the invention described herein may be employed in practicing the invention and that such alternative embodiments and equivalents fall within the scope of the present invention.

### NON-PATENT REFERENCES (PATENT REFERENCES ARE EMBEDDED IN THE RELEVANT SECTIONS OF THE SPECIFICATION)

[1] Musk, E. Neuralink, An Integrated Brain-Machine Interface Platform With Thousands of Channels, Journal of Medical Internet Research, Vol. 21, Iss. 10, e16194, 1-14. (2019).
[2] Lawhern, V. J., Solon, A. J., Waytowich, N. R., Gordon, S. M., Hung, C. P., Lance, B. J. EEGNet: a compact convolutional neural network for EEG-based brain-computer interfaces, Journal of Neural Engineering, 15 (5): 056013. (2018).
[3] Al-Saegh, A., Dawwd, S. A., Abdul-Jabbar, J. M. Deep learning for motor imagery EEG-based classification: A review, Biomedical Signal Processing and Control Vol. 63, 102172. (2021).
[4] Tabar, Y. R., Halici, U. A novel deep learning approach for classification of EEG motor imagery signals, Journal of Neural Engineering, 14: 016003. (2016).
[5] Amin, S. U., Alsulaiman, M., Muhammad, G., Mekhtiche, M. A., Hossain, M. S. Deep Learning for EEG motor imagery classification based on multi-layer CNNs feature fusion, Future Generation Computer Systems, Vol. 101, 542-554. (2019).
[6] Ma, J., Yang, B., Qiu, W., Li, Y., Gao, S., Xia, X. A large EEG dataset for studying cross-session variability in motor imagery brain-computer interface, Scientific Data, 9, Article Number: 531. (2022).
[7] Yamashita, R., Nishio, M., Do, R. K. G. et al. Convolutional neural networks: an overview and application in radiology, Insights into Imaging 9, 611-629. (2018).
[8] Lu, H., Wang, H., Zhang, Q., Won Yoon, S., Won, D. A 3D Convolutional Neural Network for Volumetric Image Semantic Segmentation, Procedia Manufacturing Volume 39, 422-428. (2019).
[9] Ekpar, F. E. A Novel Three-dimensional Multilayer Electroencephalography Paradigm, Fortune Journal of Health Sciences, Vol. 7, No. 3, 466-480. (2024).
[10] Ekpar, F. E. A Comprehensive Artificial Intelligence-Driven Healthcare System, European Journal of Electrical Engineering and Computer Science, Vol. 8, No. 3, 1-6. (2024).

What is claimed is:

1. An apparatus for managing signals or data associated with a three-dimensional multilayer electroencephalography system comprising at least one component that leverages or harnesses the characteristics of said three-dimensional multilayer electroencephalography system and/or associated signals or data.

2. The apparatus of claim 1 wherein said three-dimensional multilayer electroencephalography system operates in a non-invasive configuration.

3. The apparatus of claim 1 wherein said three-dimensional multilayer electroencephalography system operates in an invasive configuration.

4. A method for managing signals or data comprising at least one step that leverages or harnesses the characteristics of a three-dimensional multilayer electroencephalography system and/or associated signals or data.

5. The method of claim 4 wherein said three-dimensional multilayer electroencephalography system operates in a non-invasive configuration.

6. The apparatus of claim 4 wherein said three-dimensional multilayer electroencephalography system operates in an invasive configuration.

7. An apparatus for carrying out brain-to-brain communication comprising a three-dimensional multilayer electroencephalography system and at least one component that leverages or harnesses the characteristics of said three-dimensional multilayer electroencephalography system and/or associated signals or data.

8. The apparatus of claim 7 wherein said three-dimensional multilayer electroencephalography system operates in a non-invasive configuration.

9. The apparatus of claim 7 wherein said three-dimensional multilayer electroencephalography system operates in an invasive configuration.

10. A method for carrying out brain-to-brain communication comprising at least one step that leverages or harnesses the characteristics of a three-dimensional multilayer electroencephalography system and/or associated signals or data.

11. The method of claim 10 wherein said three-dimensional multilayer electroencephalography system operates in a non-invasive configuration.

12. The apparatus of claim 10 wherein said three-dimensional multilayer electroencephalography system operates in an invasive configuration.
